(19) United States
(12) Patent Application Publication
(10) Pub. No.: US 2011/0153432 A1
(43) Pub. Date: Jun. 23, 2011

(54) TOOL IN SUPPORT OF CONTENT ADVERTISING

(75) Inventor: Tim Forbes, New York, NY (US)

(73) Assignee: Forbes, Inc., New York, NY (US)

(21) Appl. No.: 12/974,947

(22) Filed: Dec. 21, 2010

Related U.S. Application Data
(60) Provisional application No. 61/289,472, filed on Dec. 23, 2009.

(51) Int. Cl. G06Q 30/00

(52) U.S. Cl. 705/14.66

(57) ABSTRACT

A system and method are provided for generating and deploying content advertisement modules (CAMs). One or more categories are defined that correspond to criteria relating to one or more publisher website users (PWUs). One or more PWUs are categorized into the categories based on one or more criteria and one or more tracking objects are generated to correspond to each of the categories. A generated tracking object is then embedded within website content data being delivered to one or more PWUs. Targeting requirements are received from an advertiser and one or more CAMs are generated, corresponding to the targeting requirements. The CAMs are then deployed to PWUs in response to a detection of a corresponding tracking object.

### FIELD OF THE INVENTION

The present invention generally relates to methods for generating and deploying content advertisement modules (CAMs) for display to users across the Internet on a multitude of websites. More particularly, the invention concerns methods for creating CAMs by utilizing third party advertising exchanges, wherein each CAM includes editorial content along with the advertisement and is targeted to specific website users based on the preferences of the advertiser.

### BACKGROUND OF THE INVENTION

The online advertising industry includes a plurality of advertising exchanges or advertising networks, operated by companies such as Yahoo!® or Google®, which serve to connect Internet advertisers, website publishers and Internet users. Such advertising exchanges place advertisements for companies, firms, individuals, and/or other advertisers on websites. Publishers partner with advertisers or allow advertisements to be delivered to their web pages in order to generate revenue in connection with their published content or for other marketing reasons. The advertising exchanges typically utilize an auction-based system to sell advertising space, which is designed to take certain inefficiencies out of the advertising marketplace by inexpensively and/or efficiently placing advertisements on websites of content publishers such as online magazines, bloggers and the like. However, such exchanges may place an advertisement on a website that is not frequented by many users who are interested in the advertised product or service, resulting in a low conversion or click-through rate. Such placement thus fails to raise any appreciable revenues for the advertiser. In addition, such systems may place the advertisement on a website that is undesirable or inappropriate from the perspective of the advertiser. For example, an advertiser promoting children's products would not want their advertisement appearing on a pornographic website. In fact, such an occurrence may hurt the advertiser's brand and/or image in the eyes of consumers. Furthermore, online advertising exchanges also may not take user characteristics into account when placing advertisements. Thus, an advertisement may be presented to consumers who are not interested, which again results in a low conversion rate or click-through rate for the advertiser and hurts revenues.

Prior art systems and methods have been considered to improve the online advertising experience for website users. For example, Swanson, U.S. Published Application No. 2009/0254424 for “Enhanced Online Advertising Experience” discloses a method for enhancing the user advertising experience. The method includes operatively integrating web content of an advertisement to be displayed with additional web content that is different from the web content displayed on the web page. Indicia are displayed in conjunction with the advertisement to indicate to the user that the advertisement includes a portal to the additional web content. When the user engages the indicia, the advertisement is altered so that a space occupied by the advertisement displays the additional web content for viewing and engagement by the user.

Dong et al., U.S. Published Application No. 2009/0171763 for “System and Method For Online Advertising Driven By Predicting User Interest” describes a system and method for predicting user interest by analyzing the correlation among advertisements and users. In general, an advertisement is correlated to an advertisement that has been previously selected by a particular user or a segment of users that includes the particular user. An advertisement-correlation engine correlates one advertisement to another or clusters correlated advertisements using item-based collaborative filtering. A user-correlation engine correlates one user to another or to a segment of users. One or more advertisements may be selected for display to a user based on their correlation with one or more advertisements previously selected by the user or persons who are in the same user-segment as the user.

What remains needed in the art, however, are methods and/or systems for providing advertisements to targeted online users that include content of interest to that user, such that the user is more likely to be interested in and follow up on (i.e., click-through) the advertisement.

### SUMMARY OF THE INVENTION

Technologies are presented herein for a system and method for generating and deploying content advertisement modules (CAMs). According to one aspect, one or more categories are defined that correspond to criteria relating to one or more publisher website users (PWUs). The PWUs are categorized into categories based on one or more criteria. One or more tracking objects are generated to correspond to each of the PWU's categories. A generated tracking object is then embedded within website content data being delivered to each PWU. Targeting requirements are received from an advertiser and one or more CAMs are generated, corresponding to the targeting requirements. The CAMs are then deployed to PWUs in response to a detection of a corresponding tracking object.

### DESCRIPTION OF THE DRAWINGS

FIG. 1 is a screen shot of a content advertisement module (CAM) that includes a content portion and an advertising section within an online display advertising space in accordance with an embodiment of the invention;

FIG. 2 is a simplified flowchart illustrating an embodiment of a method according to the invention;

FIG. 3 is a block diagram of a computer system configured for employment of a method such as the method of FIG. 2.

FIG. 3A is a screen shot of a “Create Boomerang List” menu;

FIG. 4 is a screen shot of a “Create Placement” menu;

FIG. 5 is a screen shot of a “User List” menu; and

FIG. 6 is a screen shot of a “Pride” menu.

### DETAILED DESCRIPTION OF CERTAIN EMBODIMENTS OF THE INVENTION

The details of one or more embodiments of the invention are set forth in the accompanying drawings and in the detailed description below. The features and advantages of the invention will be apparent and clearly understood by reference to the detailed description, to the drawings, and to the appended claims.

Disclosed are methods and systems for utilizing on-line advertising exchanges or advertising networks to create and distribute content advertising modules (“CAMs”) to one or more websites across the Internet. References are made to the accompanying drawings that form a part hereof, and which are shown by way of illustration through specific embodiments, arrangements, and examples.

Each CAM juxtaposes advertising and editorial content within an online display advertising-space, and the editorial-content is targeted to the user who is thus apt to be interested in both the editorial content and the advertisement. Thus, the CAM is designed to be of interest and to encourage the user to patronize the sponsor of the editorial content sponsor by clicking on the advertisement to learn more and/or to purchase the sponsor's product or service, thereby improving the click through rate of the advertisement.

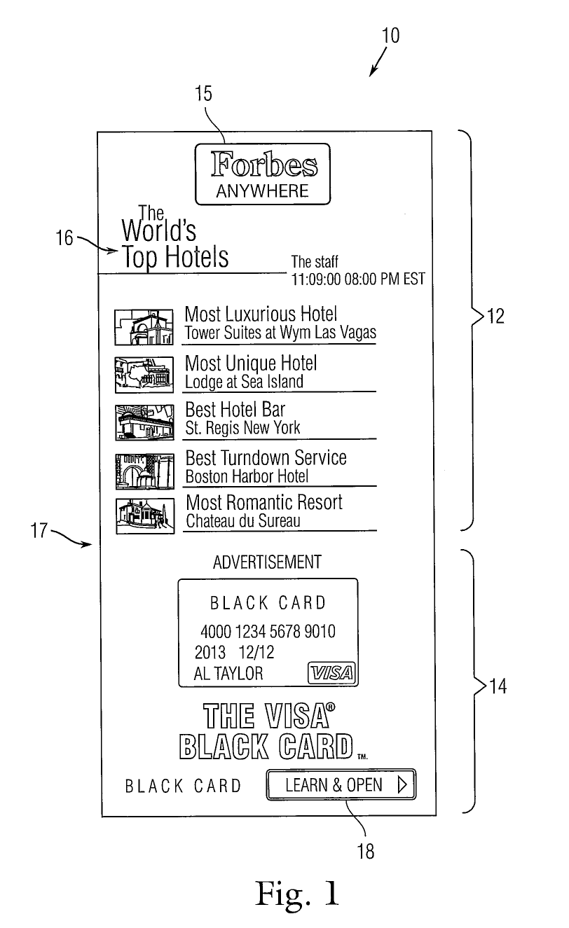

FIG. 1 is a screen shot of an embodiment of a CAM 10 that includes a content portion 12 and an advertising section 14 within an online display advertising space (which is determined in accordance with the method described below). Referring to FIG. 1, the content portion 12 includes a title 15 (“Forbes Anywhere”) that is descriptive of a publisher website, and a subtitle 16 which in this example is “The World's Top Hotels”. In this example, five different articles are referenced and an information line 17 informs the website user that a “complete listing can be found on Forbes.com.” The advertisement, in this example for “The VISA Black Card” includes a button 18 that a user may mouse over and click on to “learn more.” Other links can also be included in the content portion 12, for example each of the listed articles or stories can include a button that can be click-selected to redirect the user to a website containing the full article, and/or one or more buttons can be included in the advertisement portion 14 to enable a user to navigate to a different website containing more content and/or further information concerning the advertised product. In addition, the editorial content and/or the advertising portion can include code that enables either or both sections to expand (or balloon out) in order to provide more information or to create a larger viewing area for the user. By way of example, a window can be opened by clicking on an article title to enable the user to scroll the text of the article for easy reading without navigating away from the current webpage. These various user interactions, including clicking on or navigating within content portions 12 and advertising sections 14 of the CAM, can also be received and tracked by a central server. By way of example, a server tracks which elements within CAM 10 that a user views, interacts with, and/or selects. The server can further utilize these various interactions with CAM 10 to categorize the user, as will be described in greater detail below.

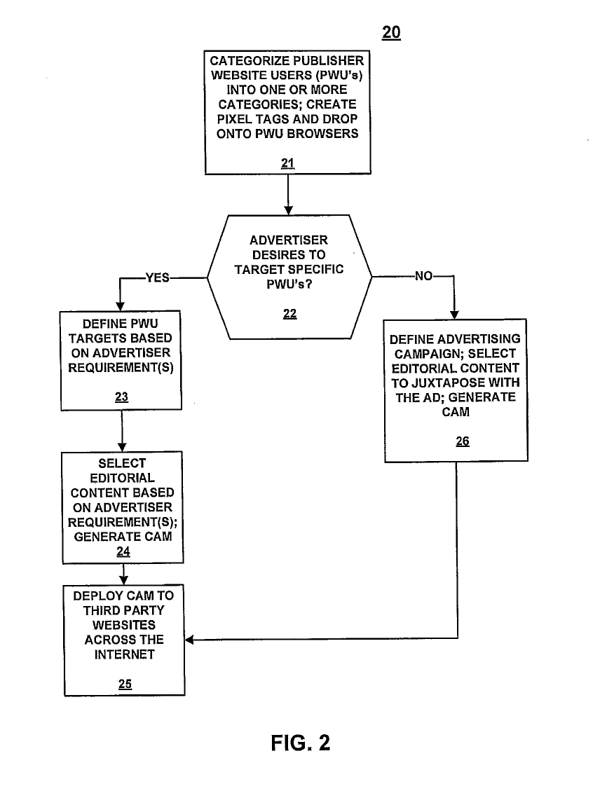

FIG. 2 is a basic flowchart 20 of a method for providing a CAM to an advertiser. The process can be performed, for example, by one or more servers, controllers, or other computing devices executing instructions in one or more processors thereof, such as may be stored and accessed from a memory, a disc, or any other such computer-readable storage device. The instructions can comprise firmware or software, and can be organized as a set of modules such as discrete code modules, function calls, procedure calls or objects in an object-oriented programming environment.

In step 21, a publisher of a website can utilize a categorizing module comprising code executing in one or more processors or computers to categorize its' users (the “Publisher Website Users” or “PWU's”) into categories. For example, the categorizing module can be configured, upon execution, to categorize each PWU as having one or more interests (in areas such as personal finance, automobiles, computers, technology, and the like), by employer (large, medium or small company or firm), and by gender and/or age. The categorizing module can access and analyze previously collected data (such as a website profile, browsing history and tendencies, etc.) to identify characteristics and interests of a particular user. The categorizing module can further incorporate ongoing user activity (such as websites that the user visits in the future) to further categorize the user. The categorizing module then applies rules (either pre-defined, user defined, or both) to the collected data, thereby assigning the user to one or more categories. By way of example, a user who visits websites relating to new car prices or reviews can be categorized as an ‘in-market car buyer.’ In one arrangement, the categorizing module accesses various tracking information (such as cookies) stored on a user's computer in order to further identify, and thereby categorize, the user. In another arrangement, a time limit and/or expiration date can be applied to the data used by the categorizing module to assign a particular user to a particular category. In doing so, the categorizing module ensures that any category assigned to a particular user will reflect the user's current interests and characteristics.

One or more designations for each PWU can be arranged, stored and managed in a database in a manner that defines each category. In an implementation, one or more publisher websites utilize their respective processor(s) to generate one or more tracking objects (such as pixel tags and/or cookies) corresponding to one or more of the publisher-selected categories. The tracking object can take on any number of forms, including a cookie having a random number and/or identifier that can serve to identify the category or categories with which the particular user is associated. The processor(s) then embeds (or “drops”) the generated tracking object within the website content data being delivered by the publisher website to the browser of one or more PWUs who have been designated as members of the specified publisher-selected category. It should be noted that the generated tracking object (such as a pixel tag) can be associated with one or more of the categories and with one or more third party advertising exchanges (for example, advertising exchanges run by Yahoo!® and/or Google®). By way of illustration, when a user identified by the categorizing module as an ‘in-market car buyer’ visits a publisher website, the website can embed a tracking object within the website content data being delivered to the user, thereby enabling the deployment of a CAM targeted to new cars, as will be described in greater detail below.

In step 22, an advertiser and the website publisher communicate a desire to place an advertisement with the publisher that optionally targets specific PWUs such as by basing the targeting on one or more of the categories mentioned above. In an implementation, a processor of a publisher-website receives targeting requirements from a computer system of the advertiser for processing. For example, if the advertiser desires to target PWUs who have an interest in technology and who are employed by medium sized companies, then in step 23 the publisher website can run processor-executable code that mines the data in the database of PWUs to create a group (or groups) of the desired population of PWUs, and utilize one or more third-party advertising exchanges to define an advertising campaign for the advertiser based on such advertiser-requirements.

In step 24, editorial content of the publisher website is selected based on the advertiser preference to target PWUs having one or more particular interests, and the CAM is generated. In an implementation, the CAM can be created to include one or more tracking objects such as pixel tags for matching to particular PWUs. The generated CAM is then uploaded to an ad server with accompanying data and/or instructions regarding the category or categories of PWUs that the CAM is targeted to.

In step 25 the CAM is deployed by an ad server to third party publisher websites across the Internet interactively and dynamically in response to a website-call of a user that had a tracking object such as a pixel tag dropped in his or her browser. The publisher website can be configured by instructions executing therein and interoperatively configured to test database contents in order to charge a fee to the advertiser that is based on the requirements specified by the advertiser for the CAM. The instructions also can be configured to charge a fee based on the editorial content provided by the publisher website. For example, the more distinctly the PWUs are targeted (that is, the more categories are used to satisfy the advertiser requirement(s)), the higher the fee that can be reasonably charged to the advertiser. In addition, the advertiser can specify through an interface of the system implementing method 20 parameters that can be stored and utilized such that several third party advertising exchanges are to be utilized, which can result in a higher total fee for the CAM associated with the advertising campaign by applying those parameters.

In an implementation, one or more publisher websites utilize their respective processors to execute instructions so as to embed at least one tracking object within the website content data being delivered to a browser of the publisher-website users (PWUs) such that the tracking object identifies at least one category, and is associated with at least one third party advertising exchange. The publisher-websites further utilize their respective processors to execute instructions that generate at least one list of publisher-website users for targeting in the advertising campaign, and select at least one particular list of publisher-website users based on the targeting requirements of the advertiser. An implementation includes utilizing a third party advertising exchange, which includes processors and/or server computers configured to receive and process data from publisher websites to generate a network-transportable content-advertising module (CAM) that includes editorial content and an advertisement of the advertiser, wherein the editorial content is selected based on an interest of the selected list of publisher-website users. The CAM is then deployed by server computers of the third party advertising exchange for transmission across the Internet and display on third party publisher-websites to the targeted publisher-website users in response to a website call by the browser of the publisher-website user.

Referring again to FIG. 2, if in step 22 the advertiser does not wish to target specific PWUs, then in step 26 the publisher website, through interaction via the interface or via instructions executing thereat, can define the advertisement campaign to include all PWUs, utilize one or more publisher-website processors to select editorial content that is to be juxtaposed with the advertisement (which content may be of general interest to each PWU), and generate the CAM. As explained above, the CAM is deployed 25 to third party publisher websites across the Internet, using servers, for example, of one or more online advertising exchanges. In this case, the publisher website can be configured by the instructions executing in that server to charge a base fee to the advertiser that can be based on the number of PWUs and/or the editorial content provided by the publisher website as two non-limiting examples.

In an implementation, category data produced by the categorizing module and associated with each PWU is stored in a searchable database. The category data can be stored in the form of one or more tables, or can be stored in other formats (including relational databases, object-based models and/or distributed databases). As noted, targeting requirements from an advertiser can be received across the Internet by the publisher website processor, which is configured by instructions executing therein to generate at least one list of PWUs for targeting in an advertising campaign. As noted, at least one particular list of PWUs can be selected based on the targeting requirements of the advertiser such that, as shown in the illustrated embodiment, a network-transportable content-advertising module (CAM) can be generated by a server computer of an online advertising exchange.

In an implementation, the editorial content is selected by the publisher-website processor based on one or more interests of the selected list of PWUs. The CAM is associated with at least one tracking object (i.e., pixel tag) and is deployed, for example, by the server computer of the online advertising exchange for display on third party publisher-websites across the Internet to the targeted PWUs in response to a website call by the browser of the PWU.

Thus, the CAM that is deployed and then later displayed to a PWU is constructed by the instructions executing in one or more processors of the system described herein on an automated basis using parameters that identify the CAM as being of interest to that PWU. A direct result of the execution of such instructions as described herein is to serve ads (namely, CAMs) that are so-adapted to increase the click-through or conversion rate for the advertiser so as to correspondingly lead to increased revenues.

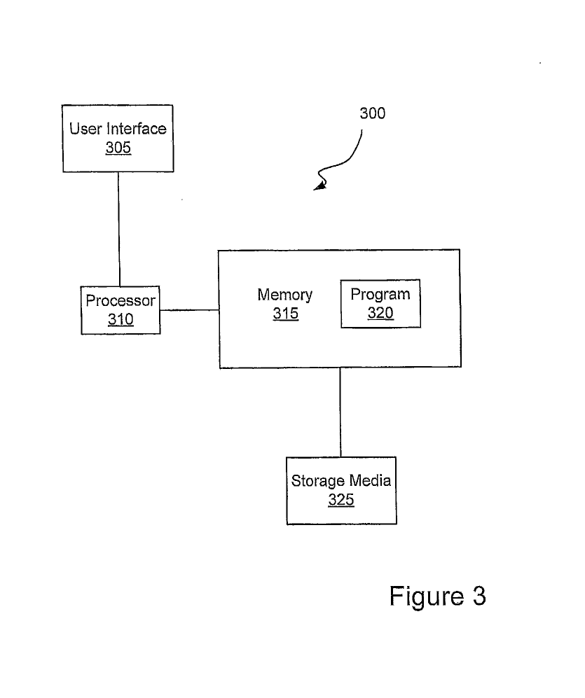

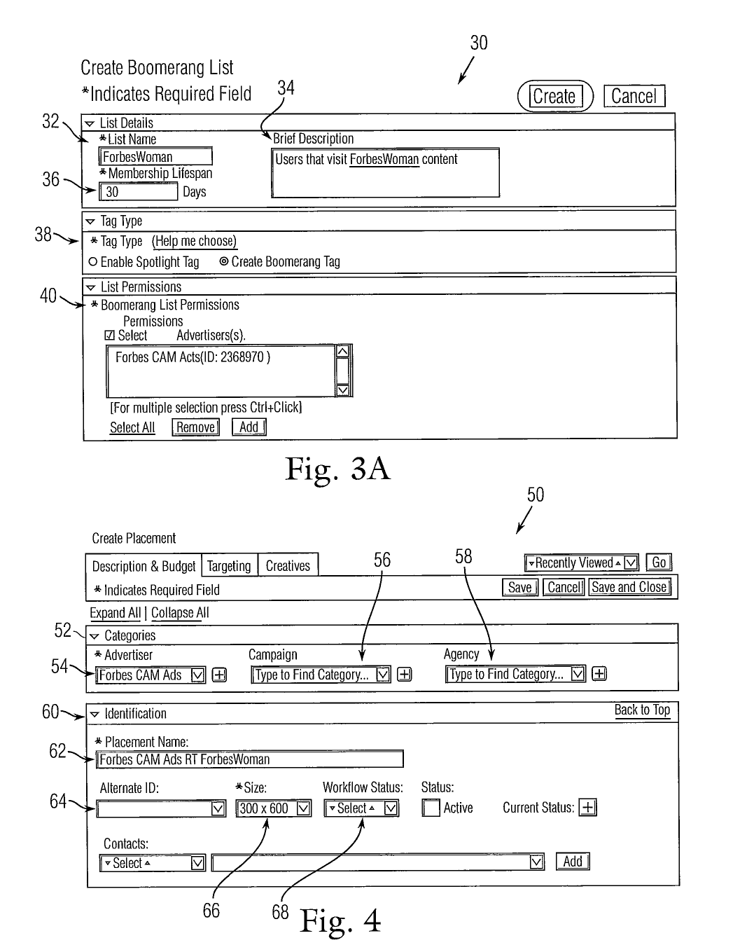

FIG. 3 is a block diagram of a computer system 300 configured for employment of method 20. System 300 includes a user interface 305, a processor 310, and a memory 315. System 300 may be implemented on a general purpose microcomputer, such as one of the members of the Sun® Microsystems family of computer systems, one of the members of the IBM® Personal Computer family, one of the members of the Apple® Computer family, or a myriad other conventional workstations, desktop computer, laptop computer, a netbook computer, a personal digital assistant, or a smart phone. Although system 300 is represented herein as a standalone system, it is not limited to such, but instead can be coupled to other computer systems via a network (not shown).

Memory 315 is a memory for storing data and instructions suitable for controlling the operation of processor 310. An implementation of memory 315 includes a random access memory (RAM), a hard drive and a read only memory (ROM). One of the components stored in memory 315 is a program 320.

Program 320 includes instructions for controlling processor 310 to execute method 20. Program 320 may be implemented as a single module or as a plurality of modules that operate in cooperation with one another. Program 320 is contemplated as representing a software embodiment of the method described hereinabove. For example, in an implementation, a plurality of program or software modules that include computer-executable instructions or code are configured to execute in one or more processors or computers to perform the functions of the methods described herein. Such program modules can include routines, programs, objects, components, data structures and the like to perform the tasks.

User interface 305 includes an input device, such as a keyboard, touch screen, tablet, or speech recognition subsystem, for enabling a user to communicate information and command selections to processor 310. User interface 305 also includes an output device such as a display or a printer. In the case of a touch screen, the input and output functions are provided by the same structure. A cursor control such as a mouse, track-ball, or joy stick, allows the user to manipulate a cursor on the display for communicating additional information and command selections to processor 310.

While program 320 is indicated as already loaded into memory 315, it may be configured on a storage media 325 for subsequent loading into memory 315. Storage media 325 can be any conventional storage media such as a magnetic tape, an optical storage media, a compact disc, or a floppy disc. Alternatively, storage media 325 can be a random access memory, or other type of electronic storage, located on a remote storage system.

In some embodiments, networks of computer systems are utilized to perform the methods described herein. For example, two or more computer systems 300 or servers can be configured to form a network of computers and/or to communicate over the Internet to create and provide a CAM to an advertiser or advertisers. Distributed computing environments can be utilized that include program modules that are stored in local and/or in remote computer storage media. In another implementation, publishers and advertisers communicate directly over a telephone connection to define the parameters or characteristics of an advertising campaign before the publisher utilizes one or more networked computer systems to generate and provide the CAM.

FIGS. 3A to 6 are screen shots of menus that can be provided in the illustrated embodiment via an interface of the software to enter information on the Google® advertising exchange in order to target particular users of the Forbes® website to create a CAM for an advertiser. Similar menus can be utilized on other third party advertising exchange websites, such as that offered by Yahoo!®, as will be explained below.

Referring to FIG. 3A, a screen shot of a menu is depicted that allows a website publisher such as Forbes® to create a “boomerang list” of tracking objects such as pixel tags for identifying their website users in a particular manner. The menu can be filled in, for example, by an employee of the Forbes® publisher website, or the process can be automated via software executing in a processor. As shown, the menu 30 includes entries for listing details such as a list name 32, a brief description 34, and a membership lifespan 36, for choosing a tag type 38, and for listing permissions 40. In this example, information has been entered to specifically target users that visit “ForbesWoman” content to receive the CAM. A membership lifespan of 30 days has been specified (see reference number 36), a boomerang tag (pixel tag) has been selected 38, and a boomerang permission has been selected. The boomerang permission, shown as “Forbes CAM Ads (ID: 2359970) pertains to a target audience of users which have been predefined. For example, ID: 2359970 may identify ForbesWoman users who also viewed personal finance content on the Forbes® website. Thus, visitors who view particular content or browse a particular content category are identified as users with an interest in that content and/or category, and a pixel tag is assigned to their website browser that associates them with that content and/or category (for example, a cookie is dropped onto their respective browsers). The pixel can include one or more third party advertising server tags or exchange tags (for example, a Yahoo!® advertising exchange tag, a Google® advertising exchange tag, and a DoubleClick® advertising exchange tag could all be assigned to a particular website user). As mentioned above, other characteristics can be used to categorize each website user, such as the size of the company at which the person is employed, the person's job title, gender, their online spending habits and so on.

FIG. 4 is a screen shot of a “Create Placement” menu 50 for use in specifying how the content advertising module (CAM) will be deployed for a first party or third party advertising server campaign. In particular, a user enters data in a categories field 52 that can be configured to include the name of the advertiser 54, the name of the campaign 56, and the agency 58. As shown, the advertiser in this example is “Forbes CAM ads”, the campaign can be given a name such as “Dell laptop specials”, and the Agency entry can be, for instance, “On behalf of the Dell Company”. Also provided are identification fields 60 that include a “Placement Name” 62, which is depicted as “Forbes CAM ads_RT ForbesWoman”, an alternative identification field 64, a size field 66 which specifies the pixel size of the banner ad, e.g., 300×600, a workflow status field 68, and a status field 70. Also shown is a contacts field 72, which is used to specify the client/customer information associated with the placement.

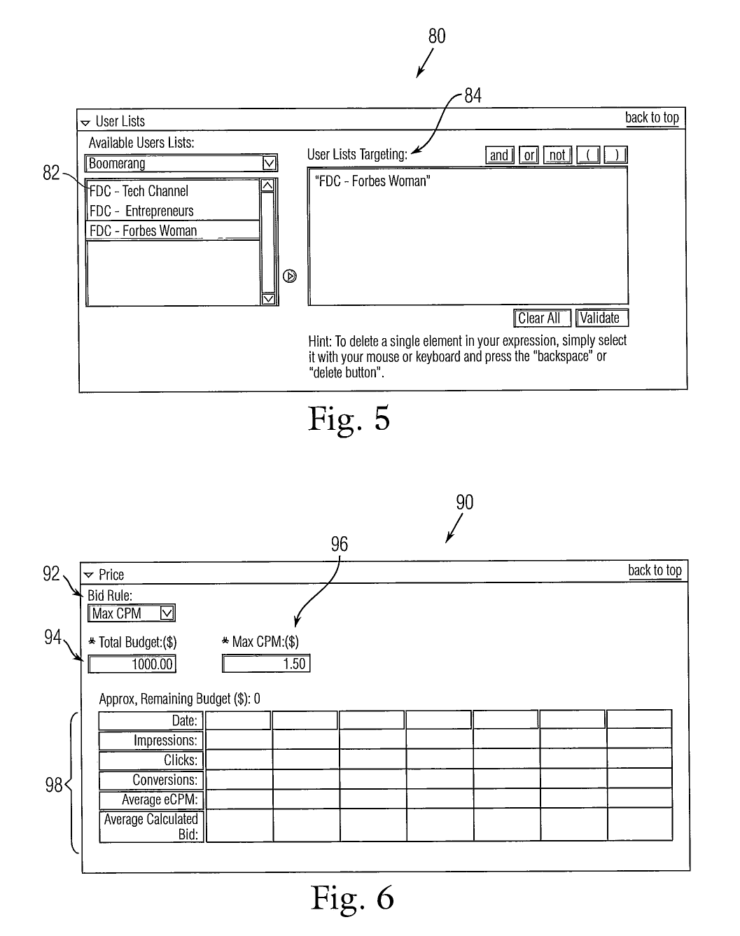

FIG. 5 is a screen shot of a user “List” menu 80 which is used to create campaigns on third party advertisement exchanges that target any website users that are identified in response to transmission of a pixeled tag cookie from their respective browsers. The list menu can include users that have shown interest in one or more content categories. The menu includes an “Available User List” 82 which lists available groupings of users by categories (e.g., a Forbes Defined Channel (“FDB”), and a “User Lists Targeting” section 84 that shows which of the available lists have been selected list.

FIG. 6 illustrates a “Price” menu 90 which is used to specify any bid rules 92, a total budget 94, and a maximum dollar amount that the advertiser is willing to pay for one thousand clicks (CPM) 96. Also shown is a results table 98 that includes metrics for particular dates which can include the number of impressions, the number of clicks, the number of conversions, the average cost for one thousand clicks, and the average calculated bid.

The methods described herein have been indicated in connection with flow diagrams that facilitate a description of the principal processes; however, certain blocks can be invoked in an arbitrary order, such as when the events drive the program flow such as in an object-oriented program. Accordingly, the flow diagram is to be understood as an example flow and that the blocks can be invoked in a different order than as illustrated.

It should be understood that various combinations, alternatives and modifications of the present invention could be devised by those skilled in the art. The present invention is intended to embrace all such alternatives, modifications and variances that fall within the scope of the appended claims.

What is claimed is:

1. A content advertisement module (CAM) generation and deployment system, the system comprising:
a processor;
a storage medium accessible by the processor;
one or more software modules encoded on the storage medium (i) which execute in the processor and (ii) which, when executed by the processor, cause the CAM generation and deployment system to:
define categories within the storage medium;
categorize publisher website users (PWUs) into the categories based on one or more criteria;
generate one or more tracking objects that correspond to each of the categories;
embed one of the tracking objects within website content data prior to delivery to a given PWU among the PWUs;
receive targeting requirements from an advertiser;
generate a CAM corresponding to the targeting requirements; and
deploy the CAM to the given PWU in response to a detection of a corresponding tracking object.

2. The system of claim 1, wherein the tracking objects comprise pixel tags.

3. The system of claim 14, wherein the tracking object is associated with one or more third party advertising exchanges.

4. The system of claim 1, wherein a CAM comprises:
editorial content; and
one or more advertisements.

5. The system of claim 1, wherein a CAM includes controls for interaction by a user.

6. The system of claim 1, wherein a CAM includes controls for manipulation by a user.

7. A computer-implemented method for generating and deploying content advertisement modules (CAMs), the method comprising:
defining categories in a memory of a machine using a processor executing one or more software modules stored on a storage medium;
categorizing publisher website users (PWUs) into the categories based on one or more criteria using the processor executing one or more software modules stored on the storage medium;
generating one or more tracking objects that correspond to each of the categories using the processor executing one or more software modules stored on the storage medium;
embedding one of the tracking objects within website content data prior to delivery to a given PWU among the PWUs using the processor executing one or more software modules stored on the storage medium;
receiving targeting requirements from an advertiser using the processor executing one or more software modules stored on the storage medium;
generating a CAM corresponding to the targeting requirements using the processor executing one or more software modules stored on the storage medium; and
deploying the CAM to the given PWU in response to a detection of a corresponding tracking object using the processor executing one or more software modules stored on the storage medium.

8. The method of claim 7, wherein the criteria include demographic information.

9. The method of claim 7, wherein the given PWU is categorized into more than one category.

10. The method of claim 7, wherein the tracking objects comprise pixel tags.

11. The method of claim 10, wherein the embedding step comprises dropping the pixel tag as the tracking object.

12. The method of claim 7, wherein the tracking object is associated with one or more third party advertising exchanges.

13. The method of claim 7, wherein the receiving step includes receiving information relating to one or more categories of PWUs that the advertiser wishes to target.

14. The method of claim 7, wherein the step of generating the CAM comprises:
selecting editorial content; and
combining the editorial content with one or more advertisements.

15. The method of claim 14, wherein the the step of generating the CAM further comprises filtering the editorial content and the advertisements based on the categories.

16. The method of claim 14, wherein the CAM is expandable in response to user input.

17. The method of claim 14, wherein the CAM includes controls for navigating within the CAM.

18. The method of claim 14, wherein the editorial content is selected in relation to one or more categories of PWUs.

19. The method of claim 7, wherein the deploying step includes deploying the CAM through a third party advertising exchange.

20. The method of claim 7, further comprising charging a fee to the advertiser based on the targeting requirements.

21. The method of claim 7, wherein the step of deploying the CAM comprises:
awaiting an outcome of an advertising auction; and
deploying the CAM associated with a winner of the advertising auction to the given PWU.
